(19) United States
(12) Patent Application Publication
(10) Pub. No.: US 2025/0382185 A1
(43) Pub. Date: Dec. 18, 2025

(54) REMOVAL OF BORON AND TITANIUM FROM SILICON

(71) Applicant: Blue Origin, LLC, Kent, WA (US)

(72) Inventors: Alexander Imbault, Sierra Madre, CA (US); Alex M. Román, Santa Monica, CA (US); Satyanarayana Venkata Emani, Glendale, CA (US); Erica Mae Pitcavage, Altadena, CA (US); Jean Chuong, Los Angeles, CA (US); Eric D. Contreras, San Dimas, CA (US)

(21) Appl. No.: 18/744,249

(22) Filed: Jun. 14, 2024

(51) Int. Cl. C01B 33/037; C25B 15/08

(52) U.S. Cl. CPC C01B 33/037; C25B 15/085

(57) ABSTRACT

A method and system for removing boron and titanium impurities from silicon is presented. An example of the method includes holding molten silicon in a container, introducing oxygen into the molten silicon from a bottom region of the container, allowing the oxygen to bubble through the molten silicon so as to oxidize at least some of the boron and titanium impurities in the molten silicon, forming a slag of boron oxide and titanium oxide on the top surface of the molten silicon, and removing the slag from the surface of the molten silicon.

### BACKGROUND

Raw materials, such as that on Earth or the Moon, may generally lead to materials with impurities that are undesired in subsequent steps of production or fabrication. For example, lunar regolith contains minerals primarily comprising elements such as silicon, titanium, aluminum, magnesium, iron, and calcium, which are typically measured and expressed in their oxide form.

Molten oxide electrolysis (MOE) is being pursued as an alternative for existing terrestrial metal production technologies as well as for in situ oxygen and metal production on planetary bodies such as the Moon. MOE is a process that may be used to reduce molten oxides to their metal or metalloid form using an electric current. Accordingly, MOE may be used as an electrometallurgical technique for production of metal or metalloids in the liquid state from oxide feedstock. For example, silicon may be derived by an MOE process. The resulting silicon, however, generally includes a number of impurities, which can significantly impact its properties and performance.

For example, boron is a common impurity in silicon. Boron negatively affects the electrical properties of silicon, reducing its conductivity. In solar cell applications, boron contamination can lead to reduced efficiency and lower energy conversion. Boron can also form deep-level defects, affecting the performance of semiconductor devices. Titanium is another impurity found in silicon. Titanium can introduce traps in a silicon lattice, affecting charge carrier mobility. Titanium may also lead to recombination centers, reducing the efficiency of solar cells and other electronic devices.

Thus, there is a keen interest in realizing ways to control impurities like boron and titanium for optimizing silicon's performance in various applications, particularly those on the Moon, for example.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic cross-section of a silicon purifying system, according to some embodiments.

FIG. 2 is a schematic cross-section of a molten oxide electrolysis system that provides oxygen to a silicon purifying system, according to some embodiments.

FIG. 3 is a flow diagram of a process for operating a silicon purifying system, according to some embodiments.

### DETAILED DESCRIPTION

This disclosure describes, among other things, a system and a method for removing boron and/or titanium impurities from silicon. Reducing the concentration of boron or titanium impurities in silicon may be particularly useful if the silicon is to be used in the fabrication of semiconductors or solar cells, where high-purity silicon is generally required. The removal of these impurities is important because they can significantly affect the electrical properties of silicon and, consequently, the performance of the semiconductor device or solar cell.

In some embodiments, a method for removing boron and titanium impurities from silicon includes holding and maintaining silicon in its molten state in a container, which may comprise refractory materials. For example, silicon may be melted and contained in a high-temperature-resistant container or may be melted in another container and subsequently poured into a second container where it is maintained in a molten state. The silicon is in a molten state so that impurities can be more easily manipulated and removed. The method continues by introducing oxygen into the molten silicon from a bottom region of the container. For example, oxygen gas may be injected into the silicon through the bottom of the container. Oxygen has a relatively high affinity for boron and titanium, forming oxides with these elements. The flow of the oxygen into the molten silicon may be controlled based, at least in part, on a measured or estimated concentration of the boron and titanium impurities in the molten silicon. For example, tests on small samples of batches of silicon may allow for measurements or estimates of the concentration of boron or titanium. The flow of oxygen may resultantly by stoichiometrically adjusted for optimal oxidization of the boron and/or titanium.

The method proceeds by allowing the oxygen to bubble through the molten silicon so as to oxidize at least some of the boron and titanium impurities in the molten silicon. As the oxygen bubbles up, it reacts with the boron and titanium impurities in the silicon to form boron oxide (B₂O₃) and titanium oxide (TiO₂). The molten silicon may be stirred or agitated to disperse bubbles of the rising oxygen. Resultantly, a slag of boron oxide and titanium oxide may form on the top surface of the molten silicon as a result of respective buoyancies of the oxidized boron and titanium. These oxides are less dense than the molten silicon, so they rise to the surface, forming a layer of slag, which may then be removed from the container. For example, once a sufficient amount of slag has accumulated, it may be removed from the surface of the molten silicon. This may be done mechanically or by tilting the container to pour off the slag.

As explained below, in some implementations, the molten silicon may be molten metallic silicon resulting, at least in part, from an oxygen reduction process of silicon dioxide or silicon oxide. Moreover, the oxygen introduced into the molten silicon may be sourced from the oxygen reduction process. In some implementations, the method may further include using a molten oxide electrolysis (MOE) system to produce the oxygen introduced into the molten silicon. Such a source of oxygen may be particularly important for implementations of these methods on the Moon, for example.

In some implementations, the silicon may include aluminum impurities. In this case, the oxygen may be allowed to bubble through the molten silicon so as to oxidize at least some of aluminum impurities in the molten silicon. Though examples describe removing boron and titanium from silicon, claimed subject matter is not limited in this respect. For example, embodiments described herein may also be applied to removing just a single element (e.g., just boron, just titanium, or just aluminum) from silicon.

In some embodiments, a system for removing boron and titanium impurities from silicon includes a container configured to maintain silicon in a molten state, ports at a bottom region of the container to provide oxygen bubbles into the molten silicon, and a skimmer configured to remove a slag of boron oxide and titanium oxide that forms on the top surface of the molten silicon. The system may further include a flow controller to control a flow rate of the oxygen bubbles provided into the molten silicon. The flow controller may be configured to control the flow rate based, at least in part, on a measured or estimated concentration of the boron and titanium impurities in the molten silicon. The system may further include a stirrer configured to be submerged in the molten silicon to disperse oxygen bubbles.

In some implementations, described below, the system may include an MOE apparatus to produce oxygen gas for the oxygen bubbles and an oxygen reduction apparatus to produce the molten silicon. MOE may be used to separate out constituent materials from a metal oxide feedstock, such as lunar or Martian regolith. If MOE is used in this way to purify any particular constituent element, for example, then subsequent removal of boron and/or titanium from silicon, as described herein, may be a step for achieving further purification.

A metal oxide in a vessel may be reduced, using MOE, into a relatively heavy liquid metal that sinks toward the bottom of the vessel. At least a portion of this liquid metal may form a liquid metal cathode. In contrast to a heavy liquid metal, some metals reduced by MOE are neutrally buoyant in, or less dense than, their associated molten oxide electrolytes and therefore float in the molten metal oxide.

In some implementations, oxide material used in the method may be derived from lunar regolith. For example, iron oxides and silicon oxides may be in lunar regolith, or in minerals found on off-Earth locations and/or objects in the Solar System, such as asteroids, moons, minor-planets, and planets, among other objects. Of course, these oxides are also present on Earth, and methods described herein may be performed on Earth, the moon, or other bodies listed above, and claimed subject matter is not limited in this respect.

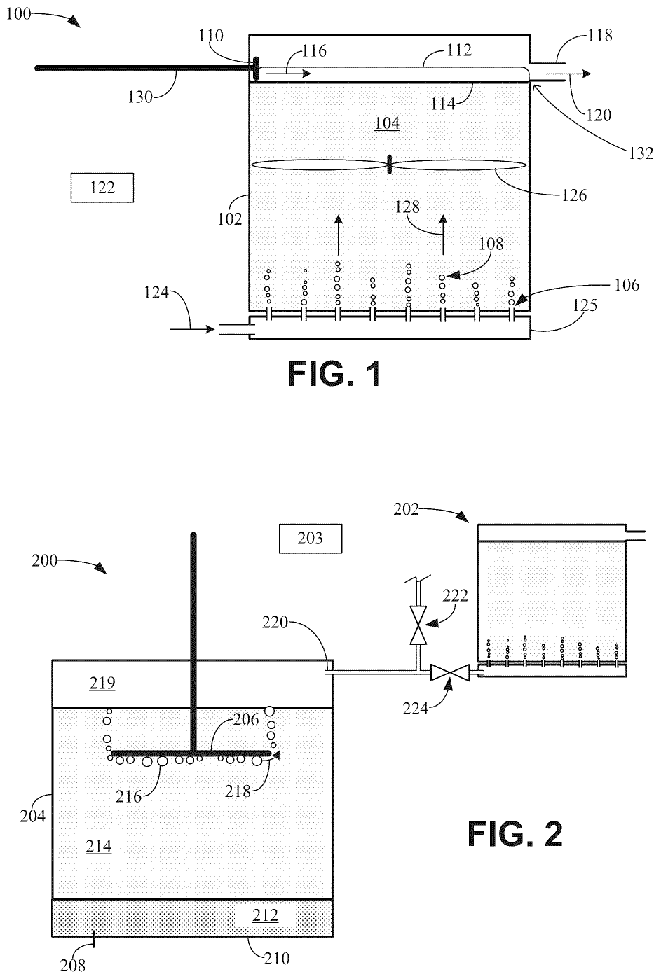

FIG. 1 is a schematic cross-section of a silicon purifying system 100, according to some embodiments. For example, system 100 may be used for removing boron and/or titanium impurities from silicon. Instead of, or in addition to, these impurities, other non-silicon components (elements) may be removed from silicon using system 100. Various portions of the system, as illustrated, are not necessarily to scale. The silicon purifying system generally comprises electrical and mechanical components that are interfaced with one another in various configurations. The silicon purifying system may further comprise one or more computer processors configured to execute computer-readable instructions, which may be directed to controlling at least some of the electrical and mechanical components.

System 100 may include a container 102 configured to hold silicon 104 in a molten state. Ports 106 at a bottom region of the container may be configured to provide oxygen bubbles 108 into the molten silicon. A skimmer 110 may be configured to remove a slag 112 of boron oxide and titanium oxide (or other oxides) that forms on a top surface 114 of the molten silicon. For example, an arrow 116 indicates a direction of motion of skimmer 110 as it skims or pushes to remove slag 112. The slag may be pushed out of container 102 by the skimmer through an exit port 118, as indicated by arrow 120.

Slag 112 may include a mixture of metal oxides (e.g., boron and titanium) and silicon dioxide. The slag may be used for various things, subsequent to its separation from the purified silicon, for example. Regarding its physical state, slag itself may not be a foam but it can foam under certain conditions. For example, slag foaming may occur when gases are generated within the slag. This can create a foam-like layer on top of the molten silicon metal.

System 100 may further include a flow controller 122 to control a flow rate of oxygen bubbles 108 provided into the molten silicon. The flow controller may be configured to control the rate of oxygen 124 entering system 100 based, at least in part, on a measured or estimated concentration of the boron and titanium impurities in the molten silicon. For example, oxygen 124 may enter system 100 via a plenum 125 that is used to distribute the oxygen into the various ports 106. The system may further include a stirrer 126 configured to be submerged in the molten silicon to disperse oxygen bubbles.

In some embodiments, system 100 may be used for removing boron and titanium impurities from silicon by a process that includes holding molten silicon 104 in container 102. Oxygen 124 may be introduced into molten silicon 104 from a bottom region of the container, such as through ports 106. Oxygen bubbles 108 rising through silicon 104, as indicated by arrow 128, may oxidize at least some of the boron and titanium impurities in the molten silicon. In particular, as the oxygen bubbles up, it reacts with the boron and titanium impurities in the silicon to form boron oxide and titanium oxide. Stirrer 126 may be used to disperse oxygen bubbles 106 in the molten silicon. Resultantly, slag 112 of boron oxide and titanium oxide may form on top surface 114 of molten silicon 104. Once a sufficient amount of slag 112 has accumulated, it may be removed from the surface of the molten silicon. This may be done mechanically by a plunger 130 pushing skimmer 110, for example, or by tilting container 102 to pour off the slag up and over an edge 132 of container 102 in exit port 118.

FIG. 2 is a schematic cross-section of an MOE system 200 that provides oxygen to a silicon purifying system 202, according to some embodiments. For example, silicon purifying system 202 may be the same as or similar to silicon purifying system 100. The oxygen provided to system 202 by system 200 may be oxygen 124.

Various portions of systems 200 and 202, as illustrated, are not necessarily to scale. For example, MOE system 200 and silicon purifying system 202 generally comprise electrical and mechanical components that are interfaced with one another in various configurations. These systems, collectively or individually, may further comprise one or more computer processors 203 configured to execute computer-readable instructions, which may be directed to controlling at least some of the electrical and mechanical components.

MOE system 200 may include a first vessel 204 (e.g., an electrolysis vessel), an anode 206 protruding into the first vessel from above, and a cathodic electrode 208, which may be located at or near the bottom 210 of the first vessel. The cathodic electrode is configured to be in electrical contact with a lower portion of contents, such as a liquid cathode 212, contained in first vessel 204. The anode and cathodic electrode may be part of a single electrolysis circuit that includes a voltage or current source (not illustrated). Accordingly, a current may flow between the anode and cathodic electrode, creating a voltage difference across molten oxide material 214 that is between the anode and cathodic electrode. For example, in some implementations, a generic composition of oxides may be: SiO2+Al2O3+MgO+FeO+CaO+SnO with trace alkali oxides and halides. The electrical current between the anode and cathodic electrode may allow for a process of electrolysis of oxide material 214. Distances between the anode and cathodic electrode may be varied to adjust voltage and/or current of the electrolysis circuit. Such variation may be useful to account for varying resistivity of molten oxide material 214 and liquid cathode 212, for example. As explained above, the electrolysis of molten oxide material 214 may produce an iron liquid cathode 212 which, in embodiments described herein, is denser than the surrounding molten oxide material. Accordingly, the liquid cathode will sink toward the bottom of first vessel 204 and thus be in electrical contact with cathodic electrode 208. It is this production of the iron liquid cathode that results in iron depletion of a portion of molten oxide material 214.

Oxygen gas may be produced from the electrolysis process performed in first vessel 204. It is this oxygen gas production that results in oxygen depletion of a portion of molten oxide material 214. In detail, the oxygen gas may generally accumulate on anode 206 as bubbles 216. Due to their buoyancy in the electrolyte, oxygen bubbles 216 may flow to the surface of the electrolyte, as indicated by arrow 218. The oxygen gas from the emerging bubbles may accumulate in a top portion 219 of vessel 204 until the oxygen gas is collected via a port 220, for example. Oxygen gas collected into port 220 may be stored for later use, via a flow valve 222, and/or may be channeled to silicon purifying system 202 via a flow valve 224, for example.

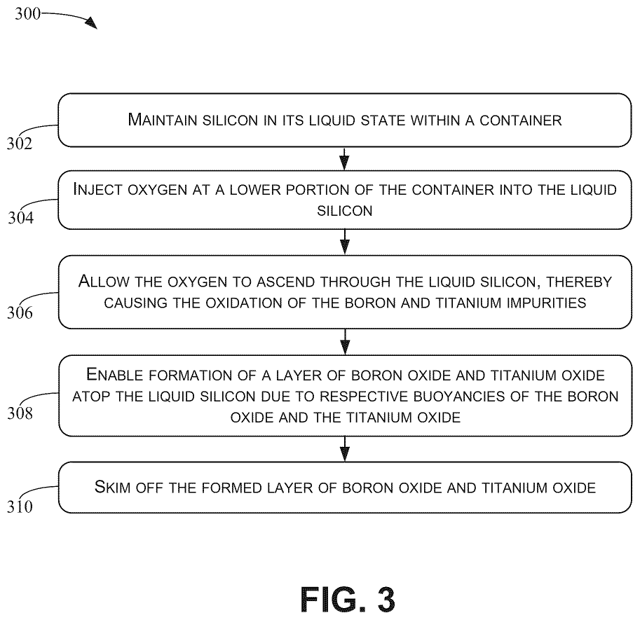

FIG. 3 is a flow diagram of a process 300 for operating a silicon purifying system, according to some embodiments. In some examples, the silicon and the oxygen may be produced by MOE, though claimed subject matter is not limited to such examples. The process may be performed by an operator, which may be a person or persons, a computer processor (e.g., 203) executing computer-readable code, or a combination thereof. The process may be performed by the operator using silicon purifying systems 100 or 202, for example.

Process 300 leverages the properties of oxygen, buoyancy, and oxidation to extract boron and titanium (e.g., and other) impurities from liquid silicon. A skimming step may be a final step that allows the impurities to be effectively separated and removed from the silicon.

At 302, the operator may maintain the silicon in its liquid state within a container, which may serve as the medium for subsequent steps. In some implementations, the liquid silicon may be molten metallic silicon resulting, at least in part, from an oxygen reduction process of silicon dioxide or silicon oxide, as described above.

At 304, the operator may inject oxygen at a lower portion of the container into the liquid silicon. For example, the injection area may be at the bottom of the container. Injecting the oxygen may facilitate an oxidation process wherein oxygen reacts with impurities such as boron and titanium that are present in the liquid silicon. In some implementations, the oxygen injected into the molten silicon may be sourced from a previously implemented oxygen reduction process. In some implementations, an MOE system may be used (e.g., previously or currently) to produce the oxygen injected into the molten silicon. A flow controller may control one or more valves to vary the flow of the oxygen injected into the molten silicon. The controlling may be based, at least in part, on a measured or estimated concentration of the boron and titanium impurities in the molten silicon, as discussed above.

At 306, the operator may allow the oxygen to ascend through the liquid silicon, thereby causing the oxidation of the boron and titanium impurities. For example, as oxygen is injected, it starts to rise through the liquid silicon due to buoyancy. During its ascent, the oxygen reacts with the boron and titanium impurities. Specifically, it oxidizes these impurities, converting them into their respective oxides (boron oxide and titanium oxide). In some implementations, the molten silicon may be stirred or agitated to disperse bubbles of the injected oxygen. In some implementations, other impurities may be at least partially removed from the silicon, such as aluminum. For example, the oxygen ascending through the molten silicon may oxidize aluminum impurities in the molten silicon.

At 308, the operator may enable formation of a layer (e.g., slag) of boron oxide and titanium oxide atop the liquid silicon due to respective buoyancies of the boron oxide and the titanium oxide. For example, as the oxidation reactions occur in the silicon, a layer of boron oxide and titanium oxide may form on the surface of the liquid silicon. The buoyant forces acting on these oxides cause them to rise and accumulate at the top of the liquid silicon. At 310, the operator may skim off the formed layer of boron oxide and titanium oxide. For example, once the boron oxide and titanium oxide layer has sufficiently formed, it can be removed from the top surface of the liquid silicon. This removal process may be performed by skimming off this oxide layer using various tools or mechanisms, such as a skimmer, horizontal “plunger,” or surface drainage (e.g., over an edge of the container), just to name a few examples. The skimming process may substantially separate the impurities (in the form of oxides) from the purified liquid silicon.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for removing boron and titanium impurities from silicon, the method comprising:
holding molten silicon in a container;
introducing oxygen into the molten silicon from a bottom region of the container;
allowing the oxygen to bubble through the molten silicon so as to oxidize at least some of the boron and titanium impurities in the molten silicon;
allowing a slag of boron oxide and titanium oxide to form on the top surface of the molten silicon as a result of respective buoyancies of the oxidized boron and titanium; and
removing the slag from the container.

2. The method of claim 1, wherein the molten silicon is molten metallic silicon resulting, at least in part, from an oxygen reduction process of silicon dioxide or silicon oxide.

3. The method of claim 2, wherein the oxygen introduced into the molten silicon is sourced from the oxygen reduction process.

4. The method of claim 1, further comprising using a molten oxide electrolysis (MOE) system to produce the oxygen introduced into the molten silicon.

5. The method of claim 1, further comprising allowing the oxygen to bubble through the molten silicon so as to oxidize at least some of aluminum impurities in the molten silicon.

6. The method of claim 1, further comprising controlling a flow of the introduced oxygen into the molten silicon, the controlling based, at least in part, on a measured or estimated concentration of the boron and titanium impurities in the molten silicon.

7. The method of claim 1, further comprising stirring the molten silicon to disperse bubbles of the oxygen.

8. A system for removing boron and titanium impurities from silicon, the system comprising:
a container configured to maintain silicon in a molten state;
ports at a bottom region of the container to provide oxygen bubbles into the molten silicon; and
a skimmer configured to remove a slag of boron oxide and titanium oxide that forms on the top surface of the molten silicon.

9. The system of claim 8, further comprising a flow controller to control a rate of the oxygen bubbles provided into the molten silicon, wherein the flow controller is configured to control the rate based, at least in part, on a measured or estimated concentration of the boron and titanium impurities in the molten silicon.

10. The system of claim 8, further comprising a stirrer configured to be submerged in the molten silicon to disperse oxygen bubbles.

11. The system of claim 8, further comprising a molten oxide electrolysis (MOE) apparatus to produce oxygen gas for the oxygen bubbles.

12. The system of claim 8, further comprising an oxygen reduction apparatus to produce the molten silicon, which is, at least in part, molten metallic silicon.

13. The system of claim 8, wherein the slag includes aluminum oxide.

14. A method for extracting boron and titanium impurities from silicon, the method comprising:
maintaining the silicon in its liquid state within a container;
injecting oxygen at a lower portion of the container into the liquid silicon;
allowing the oxygen to ascend through the liquid silicon, thereby causing the oxidation of the boron and titanium impurities;
enabling formation of a layer of boron oxide and titanium oxide atop the liquid silicon due to respective buoyancies of the boron oxide and the titanium oxide; and
skimming off the formed layer of boron oxide and titanium oxide.

15. The method of claim 14, wherein the molten silicon is molten metallic silicon resulting, at least in part, from an oxygen reduction process of silicon dioxide or silicon oxide.

16. The method of claim 15, wherein the oxygen injected into the molten silicon is sourced from the oxygen reduction process.

17. The method of claim 14, further comprising using a molten oxide electrolysis (MOE) system to produce the oxygen injected into the molten silicon.

18. The method of claim 14, further comprising allowing the oxygen to ascend through the molten silicon so as to oxidize at least some of aluminum impurities in the molten silicon.

19. The method of claim 14, further comprising controlling a flow of the injected oxygen into the molten silicon, the controlling based, at least in part, on a measured or estimated concentration of the boron and titanium impurities in the molten silicon.

20. The method of claim 14, further comprising stirring the molten silicon to disperse bubbles of the oxygen.
